(19) United States
(12) Patent Application Publication
(10) Pub. No.: US 2007/0016556 A1
(43) Pub. Date: Jan. 18, 2007

(54) Destination searching system and method

(76) Inventors: Seong Woo Ann, Gyeonggi-do (KR); Jai-Hoon Kim, Gyeonggi-do (KR); Won-Sik Yoon, Gyeonggi-do (KR); Byung-soo Kim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/180,343

(22) Filed: Jul. 13, 2005

(51) Int. Cl. G06F 17/30

(52) U.S. Cl. 707/3

(57) ABSTRACT

A destination searching system and method is provided. The system includes: a controller; an interface; a POI (Point Of Interest) hierarchically ordering unit for extracting a trade name and a geographical name from each of a plurality of POIs, hierarchically ordering and classifying an industry type, providing a description of each category, suitable classification of each POI into a category, and storing the classified POI; a query analyzing unit for, when receiving a query for a destination search, recognizing the industry type, the geographical name, and other character strings from a character string included in the received query; and a POI selecting unit for extracting a POI candidate, and selecting a POI determined to be the closest to a destination queried by a user.

### BACKGROUND OF THE INVENTION

1. Field of the Invention

The present invention relates to a destination searching system and method, and more particularly, to a destination searching system and method for hierarchically ordering a plurality of industry types, providing a description, storing each Point Of Interest (POI) in a corresponding category, and when receiving a query for a destination search, recognizing the content of the query as a collection of meaningful vocabulary words and quickly and precisely searching for a destination.

2. Description of the Related Art

In general, a destination searching system treats a user's query as one value. The destination searching system uses its building database to search a Point Of Interest (POI) having a character string consistent with the user's query. Accordingly, the destination searching system cannot search a destination POI until the query includes the same character string as a classifier (character string), which has been previously classified.

For example, a conventional destination searching system provides a plurality of input windows for allowing a user to sequentially select an administrative district unit of a search-targeted destination, and a window for inputting a character string to be used for the search. In the case where the user does not use the input window for selecting the administrative district unit, the search is performed countrywide.

When the user inputs a key word such as “giant discount mart” to search the destination, the conventional destination searching system searches and provides a POI including all or a part of the character string of “giant discount mart”. Furthermore, when the user inputs a key word such as “fast food” as the destination, the conventional destination searching system searches and provides a POI including the key word of “fast food” and a POI with its industry type classified by “fast food”. However, when the user desires to search for a “hamburger” related shop but unavoidably inputs the key word of “hamburger” due to his/her unawareness of the exact industry type, consequently only a POI with its trade name including the key word of “hamburger”, instead of information on the “hamburger” related shop, is searched.

In other words, the conventional destination searching system uses a searching method using only the industry name and the trade name. Accordingly, when the user inputs a key word (for example, “giant discount mart” or “hamburger”) representing a feature of any shop, he/she does not obtain his/her desired search result. Namely, the conventional destination searching system can perform a search beginning from the trade name to the industry type, but cannot recognize a change of a sequence of meaningful vocabulary words in the character string inputted by the user. Therefore, the conventional destination searching system is still unable to satisfactorily search for a service or feature of any given industry.

Further, the conventional destination searching system has a drawback in that there are many interfaces such as interfaces for representing a district and an interface for inputting the character string representing the destination, thereby complicating its use, and in that when it is applied to a navigation service, many processes are required and a long time is taken for a car driver to input the destination, thereby possibly causing an accident.

### SUMMARY OF THE INVENTION

Accordingly, the present invention is directed to a destination searching system and method that substantially overcomes one or more of the limitations and disadvantages of the conventional art.

One object of the present invention is to provide a destination searching system and method for hierarchically ordering industry types to intelligently search a POI, defining a service name and a feature, which can be representative of the hierarchically ordered industry types, in each hierarchy of the hierarchically ordered industry types, and utilizing the defined service name and feature in the search, thereby quickly and precisely searching for a destination.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, a destination searching system is provided including: a controller; an interface; a POI (Point Of Interest) hierarchically ordering unit for extracting a trade name and a geographical name from each of a plurality of POIs, hierarchically ordering and classifying an industry type depending on a category, providing a description of each category, suitable classification of each POI into a category, and storing the classified POI in a database; a query analyzing unit for, when receiving a query for a destination search, recognizing the industry type, the geographical name, and other character strings from a character string included in the received query; and a POI selecting unit for extracting a POI candidate with reference to the database, depending on the analysis result of the query analyzing unit, and selecting a POI determined to be the closest to a destination queried by a user.

In another aspect of the present invention, a destination searching method is provided including the steps of: classifying each of a plurality of POIs depending on a hierarchical category, providing a description of each category, and storing the provided description; receiving a query for a destination search, extracting a character string representing the category or the description for the category, from the character string included in the received query, and determining the industry type of a search-targeted POI; determining a geographical name of the search-targeted POI, from the character string included in the query; extracting at least one consistent POI with reference to the determined industry type and geographical name; and selecting the closest POI from the extracted POIs, with reference to a character string relating to the industry type and a character string excepting the geographical name, which are included in the query.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a destination searching system according to the present invention;

FIG. 2 illustrates a structure of a Point of Interest (POI) file;

FIG. 3 illustrates a structure of an optimized POI file based on the POI file of FIG. 2;

FIGS. 4 to 6 illustrate hierarchical categories of an industry type;

FIG. 7 illustrates a structure of a destination search query;

FIG. 8 illustrates an example of a geographical name file;

FIG. 9 is a flowchart illustrating a destination searching method according to the present invention;

FIG. 10 is a flowchart illustrating a POI hierarchical ordering process in the destination searching method of FIG. 9; and

FIG. 11 is a flowchart illustrating a geographical name recognizing process in the destination searching method of FIG. 9.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

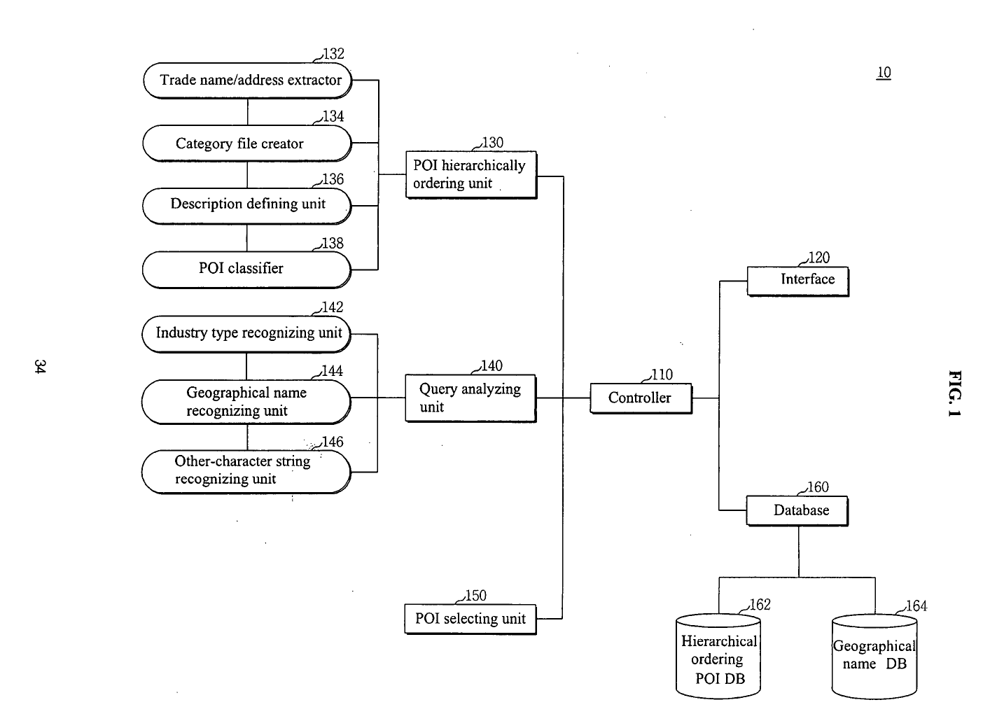

FIG. 1 illustrates a construction of a destination searching system according to the present invention.

As shown in FIG. 1, the inventive destination searching system 10 includes a controller 110; an interface 120; a POI hierarchically ordering unit 130 for extracting a trade name and a geographical name from each of a plurality of Points of Interest (POIs), hierarchically ordering and classifying types of industry based on a category, providing a description relating to a synonym of each category, or a provided service or a feature of each category, suitable classification of each POI into the category, and storing the classified POI in a hierarchical ordering POI database 162; a query analyzing unit 140 for, when receiving a query for a destination search, recognizing the industry type, the geographical name, and other character strings from a character string included in the query; a POI selecting unit 150 for extracting a POI candidate with reference to a database 160, and selecting a POI determined to be the closest to a destination queried by a user, depending on the analysis result of the query analyzing unit 140; and the database 160 including the hierarchical ordering POI database 162 and a geographical name database 164.

A more detailed description will be made below.

First, the POI hierarchically ordering unit 130 extracts only the trade name and an address from a POI file, using a trade name/address extractor 132.

FIG. 2 illustrates a structure of the POI file.

As shown in FIG. 2, the POI file initially provided includes the trade name, a coordinate, and even a full address. However, a user's query mainly includes only the trade name, and an approximate address of the destination. Accordingly, the only requirement is to extract the trade name and the address from the POI file.

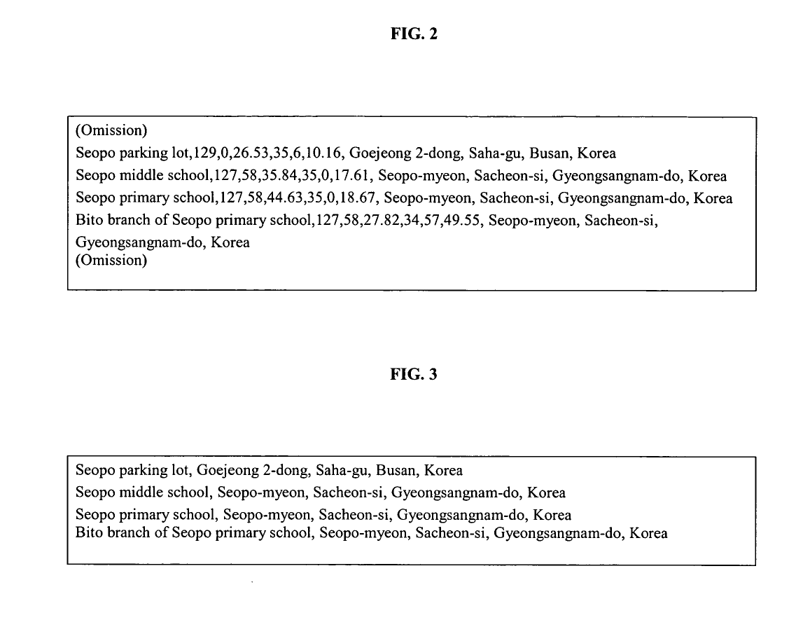

FIG. 3 illustrates a structure of an optimized POI file based on the POI file of FIG. 2. As shown in FIG. 3, it can be appreciated that an enormous amount of POI files are optimized, thereby reducing the amount of data.

Next, the POI hierarchically ordering unit 130 hierarchically orders and classifies the industry types, using a category file creator 134 for creating a category file. Here, the category file means a file having information on the industry type.

The industry type can have a hierarchical structure such as Section, Division, Group, and the like. The classification of the industry type can end at the Section, and can also be categorized into more detailed categories such as the Division and the Group.

FIGS. 4 to 6 illustrate hierarchical categories of the industry type. FIG. 4 illustrates an example of the industry type, such as education, finance, advertisement, traffic, food, and beverage, which belongs to the Section.

When the Section is defined, it is comprehensively defined to include almost all industry types if possible. Accordingly, each of the items can be categorized into a detailed industry type. For example, the item of “education” can be categorized into science, learning institute, training organization, translation, interpretation, studying abroad, language study, reading room, preschool education, and the like. As such, the items belonging to the Section can be more specifically than other categories.

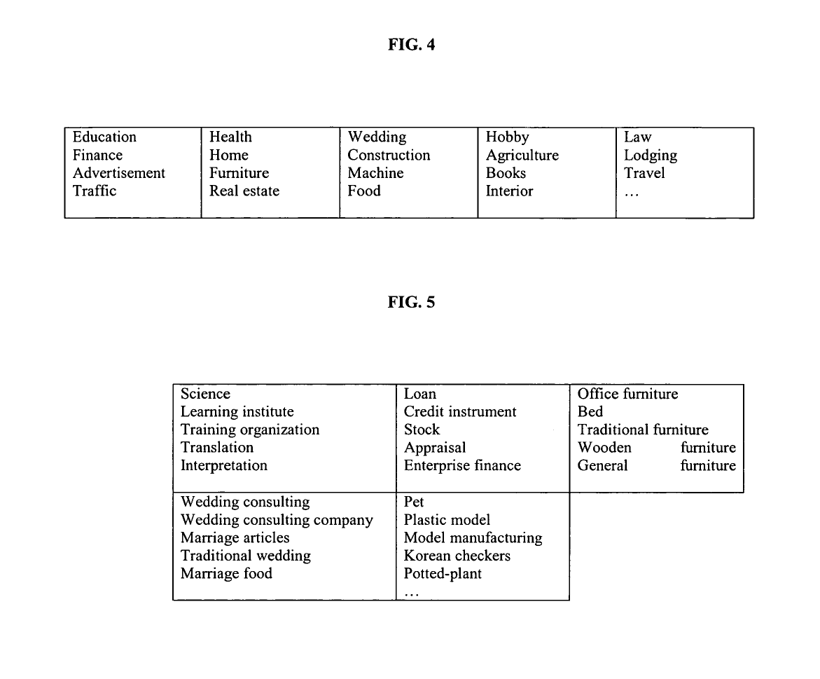

FIG. 5 illustrates items belonging to the Division, and categorized from the category of the Section of FIG. 4. In the Division, the items can be categorized further. The items of the Division can be categorized into the Group as shown in FIG. 6. For example, the item of “learning institute” can be categorized into foreign language, beauty, cooking, essay writing, and the like depending on a teaching field of the learning institute.

FIG. 6 illustrates items belonging to the Group, and categorized from the category of the Division of FIG. 5. A new classification item can be inserted to the category file as needed, and the inserted classification item is created as a new classification item file by the category file creator 134.

By doing so, each of the POIs belongs to one classification. Here, the one classification can be the Section, the Division, or the Group. For example, a POI having a trade name of “XXX University” belongs to the Group of “university”, and a POI having a trade name of “000 Bank” belongs to the Division of “bank”. As such, each of the hierarchical categories representing the POI has a tree structure.

Next, the POI hierarchically ordering unit 130 uses a description defining unit 136 to record the synonym of each category (that is, each industry type), or the provided service or the feature of each industry type in the hierarchical ordering POI database 162. Also, the POI hierarchically ordering unit 130 adds and updates the description for each category based on the contents of the user's query.

When searching the destination, the user may not be exactly aware of a name of the industry type, and may use an uncommon vocabulary word due to the uncommonness of the industry type, as a key word for the destination search. For example, when desiring to have a hamburger in a standing position, some people can search using an exact industry type name of “fast food shop”, but other people may also search using a character string of the name of the desired goods, that is, “hamburger”. In preparation for this case, a representative name of goods, or a vocabulary word capable of being representative of the industry type is recorded for each industry type or some industry types, and is used in the search.

Further, when the user succeeds in the search using his/her query, he/she selects a corresponding POI. However, upon failing, he/she changes the contents of the query and inputs a modified query. Following this process, the description defining unit 136 records the query history in the database 160, and this recording process continues until the destination search succeeds. When a plurality of users inputs the same query and fail the destination search and then finally select the same destination, the description defining unit 136 determines the same failure query to be a useful description for the corresponding category, and updates or adds the description for each category using the same failure query. Therefore, it is desirable that the destination searching system additionally includes a separate database for recording the query history.

Finally, the POI hierarchically ordering unit 130 uses a POI classifier 138 to classify each of the POIs based on a type (industry type) indicated by the trade name, and prepare each of the classified POIs in the format of a separate file. For this, the hierarchical category file and trade-name POI are required. The trade name POI is classified according to a standard classification item defined in the hierarchical category file. First, the POI classifier 138 reads any one of the standard classification items from the hierarchical category file, and records the name of the read standard classification item in the classification attribute of the database. Further, the POI classifier 138 sequentially reads the trade name POI from beginning to end, and determines whether or not the character string of the read trade name POI is consistent with the standard classification item. At this time, the trade name only has to include the standard classification item. This process is repeated at each hierarchical standard classification item. If this process is repeated until all contents of the hierarchical category files are read, the standard classification item is recorded for all POIs included in the standard classification item and resultantly, the hierarchical ordering POI database 162 is built.

An industry type recognizing unit 142 of the query analyzing unit 140 recognizes meaningful industry-type information or the character string representing the trade name from the inputted query. If the industry type recognizing unit 142 does not recognize the character string representing the industry type or the trade name, it refers to the description for the industry type, and resultantly searches the industry type information.

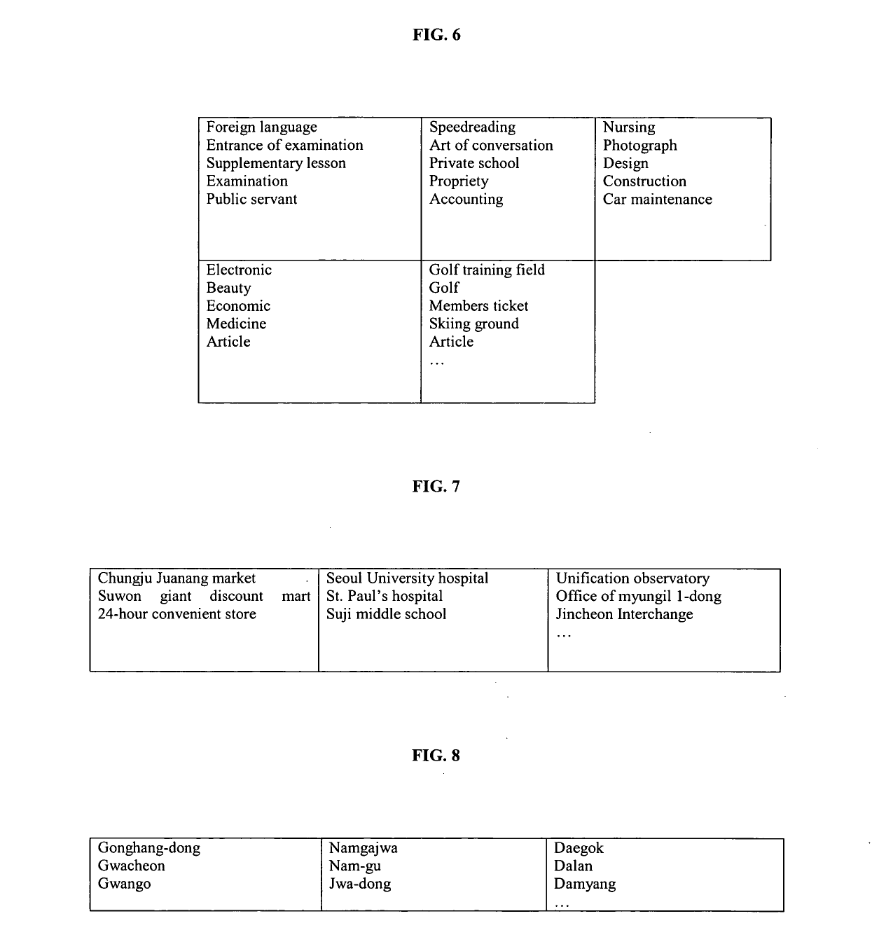

FIG. 7 illustrates a structure of a destination search query.

Looking at several queries shown in FIG. 7, it can be appreciated that a query of “Suwon giant discount mart” is comprised of the geographical name and the description (key word), and that a query of “24-hour convenience store” is comprised of the industry type and the description (key feature). Most of the queries include the industry type, or a vocabulary word capable of being representative of the industry type. Therefore, the industry type is separated from the user's query, to search only the category file classified on the basis of the separated industry type, thereby reducing the amount of data which should be searched in response to the query. Accordingly, necessary information is extracted from the query using the industry type recognizing unit 142.

A method of recognizing the industry type from the user's query is similar to a method of one's understanding a sentence. One can see and understand any sentence because he/she is already aware of a sentence building method and the meanings of the vocabulary words constituting the sentence. Similarly, if the industry type recognizing unit 142 is previously constructed to recognize a construction and a vocabulary meaning of the sentence, query recognition can be also flexibly processed. When the trade name is recognized from the query, the recognized trade name has only to be used as the resultant POI.

Next, in the query analyzing unit 140, a geographical name recognizing unit 144 extracts geographical name information from the query inputted by the user. For this, the destination searching system 10 includes the database 164 for storing the geographical name information.

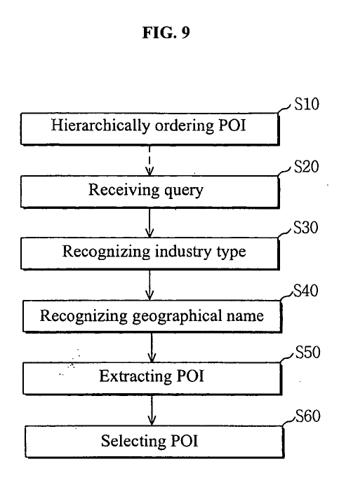

FIG. 8 illustrates an example of a geographical name file.

As appreciated from FIG. 8, it cannot be determined from the geographical name database 164 whether or not the geographical name belongs to any administrative district unit, and only the geographical name is recorded. Actually, most POI files do not express units of “city”, “province”, “county”, and “neighborhood”.

Some user's queries do not include the geographical names. In this case, the geographical name recognizing unit 144 performs the search on a countrywide basis, or performs the search by substituting the geographical name with a terminal position, which is transmitted from a terminal requesting to search a current destination. Specifically, meaningful geographical name information can employ a district where a navigation service terminal is currently located. Further, when the user intends to search any POI neighboring his/her standing position, it is a disadvantageous redundancy that he/she always inputs the geographical name of his/her location in response to the destination query. Accordingly, in the case where the current position of the terminal can be detected, it is desirable that the name of the terminal positioning place is used as the geographical name.

As such, the query analyzing unit 140 uses the industry type recognizing unit 142 to search the query for the industry type or the trade name. In the case where the query does not include the character string representing the industry type or the trade name, the description representing the industry type is used. When the name of the industry type is searched out, the description of a lower hierarchy based on a hierarchy where the searched industry type is included is referred. In the case where the query does not include the industry type, an industry type having the most consistent description is selected using the entire description. By doing so, the rate of success in searching the destination can be improved. Further, the description for the industry type is used as a secondary reference in preparation for the case where the industry type is not searched. Therefore, when the industry type or the trade name is searched from the query, the description for the industry type does not need to be used.

Character strings other than the character string representing the industry type (or description for the industry type, or the trade name) and the geographical name are processed in an other-character string recognizing unit 146, and is used when a final POI is later selected in a POI selecting unit 150.

The POI selecting unit 150 extracts at least one POI satisfying the industry type (or trade name) and the geographical name information, which are recognized in the industry type recognizing unit 142 and the geographical name recognizing unit 144, from the hierarchical ordering POI database 162, and selects the nearest POI using the character string recognized in the other-character string recognizing unit 146.

FIG. 9 is a flowchart illustrating a destination searching method according to the present invention.

For the destination search, the POI hierarchically ordering unit 130 classifies the enormous amount of POIs based on a predetermined hierarchical category, and provides the description, such as the synonym, the key word, the provided service or the feature, to each category to build the hierarchical ordered POI database (Step 10).

Once the database is built, and the query for the destination search is received from the user (Step 20), the industry type recognizing unit 142 extracts the character string representing the industry type or the description for the industry type, from the character string included in the query, and determines the industry type of the search-targeted POI with reference to the hierarchical ordering POI database 162 (Step 30). At this time, in the case where the query includes the trade name, the corresponding trade name is used as the POI.

The geographical name recognizing unit 144 refers to the character string included in the query and the geographical database 164, and determines the geographical name of the POI, which the user intends to search (Step 40). If the query does not include the character string representing the destination, a search-targeted geographical name can be on a countrywide basis or the current position of the terminal transmitting the query. Its detailed description will be made later.

Once the industry type (or trade name) and the geographical name are determined as described above, the POI selecting unit 150 refers to the hierarchical ordering POI database 162, and extracts the plurality of POIs of the district, which the user intends to search (Step 50).

After that, the POI selecting unit 150 selects the nearest POI with reference to character strings other than the character strings of the industry type and the geographical name, which are recognized in the other-character string recognizing unit 146 (Step 60).

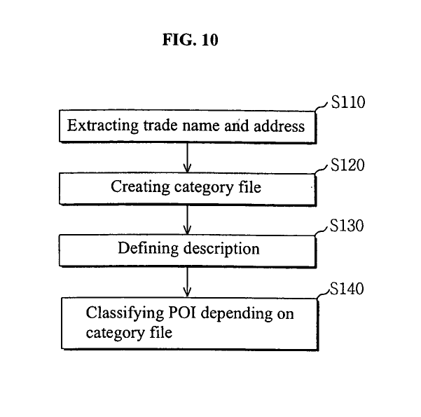

FIG. 10 is a flowchart illustrating a POI hierarchical ordering process in the destination searching method of FIG. 9.

In order to build the hierarchical ordering POI database 162, the trade name/address extractor 132 extracts only the trade name and the address from an original POI file including the trade name, the coordinate, and the full address (Step 110). After that, the category file creator 134 hierarchically orders the plurality of industry types in the Section, the Division and the Group, and creates the hierarchical ordered industry types in a format of file (Step 120). Next, the synonym, the feature, and the provided service of each category are provided, as the description, to each category file (Step 130). After that, each of the POIs are included and classified in a suitable category (Step 140).

As described above, the POI is not only classified by the trade name and the industry type, but also by the synonym, and the provided service or the feature of the industry type can be defined, thereby enabling an precise search even when the trade name or the industry type is not inputted as the query, and reducing the time taken to perform the search due to the hierarchical ordering of each industry type.

The description defining process is periodically repeated so that the description by the categories can be updated or added.

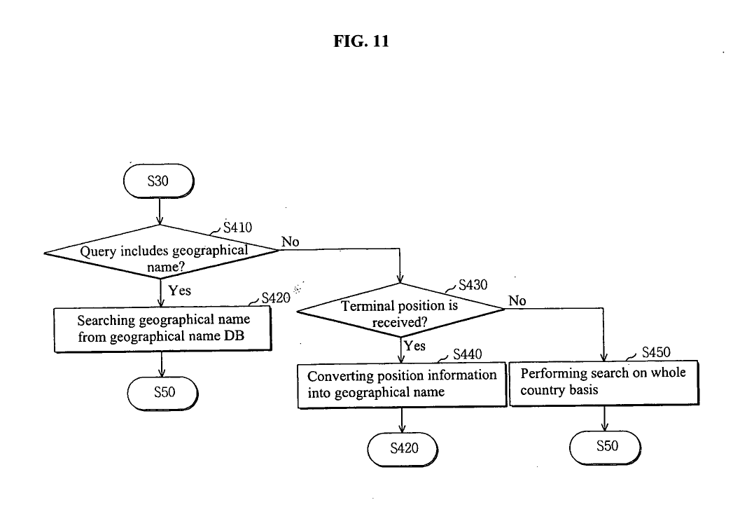

FIG. 11 is a flowchart illustrating a geographical name recognizing process in the destination searching method of FIG. 9.

The query, which is inputted for the destination search by the user, may include or may not include the geographical name information. Accordingly, the geographical recognizing unit 144 checks whether or not the query includes the geographical name (Step 410). If it is confirmed that the query includes the geographical name, it is checked whether or not the geographical name included in the query exists in the geographical name database 164. If the geographical name of the query exists in the geographical name database 164, the geographical name of the query is used as the search-targeted geographical name (Step 420).

If it is confirmed that the query does not include the geographical information, a check is performed as to whether or not the position of the terminal requesting the search is received (Step 430). If the terminal position is received, the terminal position is converted into the geographical name (Step 440), and the geographical name is searched from the geographical database 164 on the basis of the converted geographical name and is used as the search-targeted geographical name.

If the query does not include the geographical name information, and the terminal position is not received, the whole country is determined as the search basis (Step 450).

As described above, in the present invention, when the query inputted by the user includes an exact trade name or industry name information, the hierarchical category can be searched to promptly find the POI, and even when the query does not include an exactly trade name or industry type information, the search can be performed with reference to the description provided of each category, thereby providing a result to the research requested by the user.

Also, when the query does not include the geographical name information, the search is performed on a countrywide basis or the position of the terminal requesting the query, thereby searching the desired destination even though the geographical name information is not inputted in duplicate.

The present invention classifies each industry type by a hierarchical category, provides a description (feature and provided service) to each category, stores each POI suitably to the corresponding category, and then, if the query for the destination search is received from the user, exactly recognizes the industry type and the geographical name, thereby promptly and precisely performing the destination search.

Further, in the case where the query does not include the geographical information, the current position of the terminal transmitting the query is used as the geographical name information, thereby solving the inconvenience of inputting the geographical name information into the destination query.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A destination searching system comprising:
a controller;
an interface;
a POI (Point Of Interest) hierarchically ordering unit for extracting a trade name and a geographical name from each of a plurality of POIs, hierarchically ordering and classifying an industry type depending on a category, providing a description to each category, suitable classification of each POI into the category, and storing the classified POI in a database;
a query analyzing unit for, when receiving a query for a destination search, recognizing the industry type, the geographical name, and other character strings from a character string included in the received query; and
a POI selecting unit for extracting a POI candidate with reference to the database, depending on the analysis result of the query analyzing unit, and selecting a POI determined to be the closest to a destination queried by a user.

2. The system according to claim 1, wherein the description comprises a synonym, a key word, a provided service, and a feature of the category.

3. The system according to claim 1, wherein the POI hierarchically ordering unit comprises:
a trade name/address extracting unit for extracting the trade name and the address from each of the plurality of POI files;
a category file creating unit for classifying a plurality of industry types by a plurality of categories, and hierarchically ordering the classified categories to provide at least one lower category;
a description defining unit for providing a description to each of the classified categories; and
a POI classifying unit for classifying and storing each of the plurality of POIs depending on the category.

4. The system according to claim 3, wherein the description defining unit adds or updates the description provided to each category on the basis of the query for the destination search.

5. The system according to claim 1, wherein the query analyzing unit comprises:
an industry type recognizing unit for extracting a character string representing the category or the description for the category, from the character string included in the received query, and determining the industry type from the extracted character string;
a geographical name recognizing unit for extracting and recognizing geographical name information from the character string included in the query; and
an other-character string recognizing unit for recognizing a remaining character string, except for the character string for recognizing the industry type and the character string for recognizing the geographical name, from the character string included in the query.

6. The system according to claim 5, wherein when the character string included in the query includes the trade name, the industry type recognizing unit determines the trade name as the POI.

7. The system according to claim 5, wherein when the character string included in the query does not include the geographical name information, the geographical name recognizing unit recognizes the whole country as a search basis.

8. The system according to claim 5, wherein when the character string included in the query does not include the geographical name information, the geographical name recognizing unit recognizes the position information of a terminal which transmits the query as the search basis.

9. A destination searching method comprising the steps of:
classifying each of a plurality of POIs depending on a hierarchical category, providing a description of each category, and storing the provided description;
receiving a query for a destination search, extracting a character string representing the category or the description for the category, from the character string included in the received query, and determining the industry type of a search-targeted POI;
determining a geographical name of the search-targeted POI, from the character string included in the query;
extracting at least one consistent POI with reference to the determined industry type and geographical name; and
selecting the closest POI from the extracted POIs, with reference to a character string relating to the industry type and a character string not specifying the geographical name, which are included in the query.

10. The method according to claim 9, wherein the description comprises a synonym, a key word, a provided service, and a feature of the category.

11. The method according to claim 9, wherein in the determination of the industry type, when the query includes the character string representing a trade name, the trade name included in the query is determined as a search-targeted POI.

12. The method according to claim 9, wherein the hierarchical ordering of the POIs comprises the steps of:
extracting a trade name and an address from a POI file including the trade name, a coordinate, and a full address;
classifying a plurality of industry types by a plurality of categories, and hierarchically ordering the classified categories;
providing the description to each category; and
classifying and including each POI in a suitable category.

13. The method according to claim 9, wherein the determination of the geographical name comprises:
checking whether or not the query includes the geographical name;
if it is confirmed that the query includes the geographical name, the geographical name included in the query is used as a search-targeted geographical name;
if it is confirmed that the query does not include the geographical name, a check is performed as to whether or not the position of a terminal transmitting the query is received;
when the terminal position is received, the terminal position is converted into the geographical name, and the converted geographical name is used as the search-targeted geographical name; and
when the terminal position is not received, determining the whole country as a search basis.
